(19) United States
(12) Patent Application Publication
(10) Pub. No.: US 2004/0023695 A1
(43) Pub. Date: Feb. 5, 2004

(54) Electronic device for communicating with a mobile radio device

(76) Inventor: Oliver Zechlin, Stein (DE)

Correspondence Address: BELL, BOYD & LLOYD, LLC, P. O. BOX 1135, CHICAGO, IL, 60690-1135, US

(21) Appl. No.: 10/398,117

(22) PCT Filed: Sep. 11, 2001
(86) PCT No.: PCT/DE01/03489

(30) Foreign Application Priority Data
Sep. 26, 2000 (DE) 10047650.3

(51) Int. Cl. H04M 1/00

(52) U.S. Cl. 455/566; 455/575.1

(57) ABSTRACT

The invention relates to an electronic device for communicating with a mobile radio device, particularly with a mobile telephone. The electronic device contains a communications software, which is stored in a memory, and which can be called up and controlled using a keyboard (10). Said software comprises at least one menu, which is provided with features and/or functions of thc mobile radio device, which can be displayed on a display screen (13) of the device, and which is provided by said communications software. In order to directly activate the communication of the electronic device with a mobile radio device, the invention provides that the keyboard (10) has a hard-wired key (14) for directly calling up the menu.

The present invention relates to an electronic device for communicating with a mobile radio device, particularly with a cellular telephone, for example with a mobile handset, comprising communications software which is stored in a memory and which can be called up and controlled via a keyboard, said communications software comprising at least one menu which lists features and/or functions of the mobile radio device, which can be displayed on a display screen of the device and which is provided by the communications software.

An electronic device of this type is a device which itself is not a mobile radio device and/or possesses no mobile radio device function, such as, say, an organizer or a notebook. It is already known that with the aid of such a device functions on a mobile radio device or features of a mobile radio device can be called up. Such functions include, for example, a function for sending an SMS message, for editing the electronic phone book of the mobile radio device, for setting call forwarding on the mobile radio device, and so on. Communication between the electronic device and the mobile radio device has taken place to date with the aid of communications software, in that this software, which is stored in a memory of the electronic device, is called via the keyboard of this device, and by navigation within the communications software, for example by means of a menu provided in this. This type of communication between the electronic device and the mobile radio device is laborious and these days cannot be simply presented to the user who is spoiled in terms of ease of use.

The object of the invention is to create an electronic device of the type referred to at the beginning, in which features and/or functions of the mobile radio device can be accessed directly without any effort.

This object is achieved by the features set out in claim 1. Advantageous developments of the invention are specified in the sub-claims.

Instead of laboriously calling up the communications software and navigating through this until the desired type of communication is reached, as is the case with the prior art, the invention provides a hardwired key, called a hardkey, which is integrated in the electronic device, i.e. in its keyboard. Thus, the features that can be called by the electronic device and/or functions of the mobile radio device that were cited above as an example are available to a user at any time at the press of a key. Said features and functions also include retrieving newly received short messages and sending responses to them.

Through the simple measure according to the invention of using a hardwired key for direct invocation of the communications software, a novel, greatly simplified operating concept is provided to enable communication between electronic device and mobile radio device.

The arrangement and type of the key in the keyboard of the electronic device can be implemented in a number of different ways, preferably with regard to ergonometrics and/or use of given possibilities of the keyboard.

Thus, according to a preferred variant, the hardwired key is disposed at a prominent point on the keyboard so that no tedious and protracted searching for this key in the keyboard is necessary. With this consideration, the key is preferably disposed at the edge of the keyboard, and here, in turn, preferably at a corner of the keyboard.

In order to be able to recognize or relocate the key easily, it preferably has a form that distinguishes it from that of the other keys of the keyboard.

In each implementation or arrangement of the key in question, this is advantageously provided with a symbol designating the mobile radio device, for example with the familiar outline of a mobile phone.

As an alternative to the hardwired key provided separately from other keys to allow direct call-up of the menu of the communications software, this key can also be implemented as a second function of a dual-function key, which can be activated, for example, using the control key of the keyboard.

In the following the invention is explained in greater detail with the aid of drawings by way of example; the only figure of the drawing shows a bird's eye view of an electronic device without dedicated radio and/or telephone function in the form of an organizer with raised display, thus exposing the keyboard. The rectangular base unit of the electronic device implemented as an organizer and provided for communicating with a mobile radio device is identified by the reference number 10. The electronics of the organizer including memory resources is contained in the base unit 10. A part of the topside of the base unit 10 is taken up by a keyboard 11, by means of which the organizer can be controlled and via which data etc. can be input. Joined to the upper edge of the base unit 10 is a hinged lid 12, which has roughly the same contour as the base unit 10 and which has a display in the form of a screen 13 on the inside.

The organizer is designed to enable communication with a mobile radio device, for example via a cable, or wirelessly by infrared. For this purpose, communications software is stored in a memory of the organizer. This communications software can be called up and controlled via the keyboard. The special characteristic according to the invention provides that this communications software can be activated by means of a hardwired key. In the embodiment described, this key is of circular form and is disposed at the upper left-hand corner of the keyboard 11 and generally identified by the reference number 14. To indicate the unique assignment of its function, the key 14 is provided with an appropriate symbol, such as, for example, with the typical outline of a mobile phone.

By actuating the key 14, a user immediately gains access at any time to the functions and/or features of the mobile radio device that is to be remotely controlled. A display associated with the actuation of the key 14 on the display screen 13 comprises a menu 15 which is bordered by a rectangular box 16, in the top right-hand corner of which an icon denoting communication with the mobile radio device is displayed. This icon 17, which unmistakably alerts a user to the activated function of the electronic device, namely to the activated communications software, is represented in the illustrated embodiment as a telephone linked to a globe via a connecting cable.

The heading of the menu 15 reads “Do you want to” followed by four lines with the contents:

1. send an SMS?

2. send an eMail?

3. send a Fax?

4. change your phone setup?

With the aid of up/down keys, a user navigates through the menu and clicks one of the four lines in order to activate the corresponding function or feature of the mobile radio device.

With the aid of the hardwired key 14 it is possible, in other words, to select the communication and control functions relevant to the mobile radio device on a context-dependent basis by a simple key depression.

1. Electronic device for communicating with a mobile radio device, particularly with a cellular telephone, for example with a mobile handset, comprising communications software which is stored in a memory and which can be called up and controlled via a keyboard (10), said communications software comprising at least one menu which lists features and/or functions of the mobile radio device, which can be displayed on a display screen (13) of the device and which is provided by the communications software, characterized in that the keyboard (10) includes a hardwired key (14) enabling direct invocation of the menu.

2. Mobile radio device according to claim 1, characterized in that the key (19) is disposed at a prominent point on the keyboard (10).

3. Mobile radio device according to claim 2, characterized in that the key (14) is disposed at an edge of the keyboard (10).

4. Mobile radio device according to claim 2 or 3, characterized in that the key (14) is disposed at a corner of the keyboard (10).

5. Mobile radio device according to one of the claims 1 to 4, characterized in that the key (14) has a form that differs from that of the other keys of the keyboard (10).

6. Mobile radio device according to one of the claims 1 to 6, characterized in that the key (14) is provided with a symbol designating the mobile radio device.

7. Mobile radio device according to one of the claims 1 to 3, characterized in that the key (14) is a dual-function key, the second function of which can be accessed using the control key.
